(19) United States
(12) Patent Application Publication
(10) Pub. No.: US 2025/0074476 A1
(43) Pub. Date: Mar. 6, 2025

(54) SHARED CONTROL APPROACH FOR HIGHLY DYNAMIC VEHICLE OPERATION

(71) Applicant: TOYOTA RESEARCH INSTITUTE, INC., Los Altos, CA (US)

(72) Inventors: Izumi KARINO, Susono (JP); Yan Ming Jonathan GOH, Los Angeles, CA (US); James Andrew DALLAS, San Jose, CA (US); Michael THOMPSON, San Juan Capistrano, CA (US); Minoru Brandon ARAKI, Saratoga, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/460,304

(22) Filed: Sep. 1, 2023

(51) Int. Cl. B60W 60/00; B60W 50/00; B60W 50/14

(52) U.S. Cl. CPC B60W 60/005; B60W 50/0097; B60W 50/0098; B60W 50/14; B60W 2050/0062

(57) ABSTRACT

A method for a shared control, dynamic driving system is described. The method includes determining a vehicle command requested by a vehicle operator of an ego vehicle. The method also includes predicting the ego vehicle entering an unstable, controllable operating range if the vehicle command is performed. The method further includes adjusting the vehicle command to maintain control of the ego vehicle in the unstable, controllable operating range. The method also includes performing an adjusted vehicle command to operate the ego vehicle in the unstable, controllable operating range while maintaining recovery stability to transition to a safe operating range.

### BACKGROUND

### Field

Certain aspects of the present disclosure relate to autonomous vehicle technology and, more particularly, to a shared control approach for highly dynamic vehicle operation.

### Background

Autonomous agents (e.g., vehicles, robots, etc.) rely on machine vision for sensing a surrounding environment by analyzing areas of interest in a scene from images of the surrounding environment. Autonomous agents, such as driverless cars and robots, are quickly evolving and have become a reality in this decade. The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle, then the autonomous vehicle with a higher-level number offers a greater combination and quantity of autonomous features relative to the other vehicle.

These various levels of autonomous vehicles may provide a safety system that improves driving of a vehicle by providing a set of advanced driver assistance system (ADAS) features, which may include electric stability control (ESC) systems. ESC systems are a type of shared control system that stabilizes vehicles under a restrictive target yaw rate where rear tire forces are not saturated. In some cases, this constraint is designed to keep the vehicle within a region referred to as a stable handling envelope (SHE), which is an open-loop stable region, in which ordinary drivers can easily drive as intended. Many shared control research studies have been conducted within this region for practical advanced driver assistance systems as this simplifies controller design and keeps the vehicle in an easier to control region where unstable dynamics can be avoided. Nevertheless, maintaining vehicle operation within the noted SHE region comes with a sacrifice; namely, this trades off agility of the vehicle for stability and safety.

### SUMMARY

A method for a shared control, dynamic driving system is described. The method includes determining a vehicle command requested by a vehicle operator of an ego vehicle. The method also includes predicting the ego vehicle entering an unstable, controllable operating range if the vehicle command is performed. The method further includes adjusting the vehicle command to maintain control of the ego vehicle in the unstable, controllable operating range. The method also includes performing an adjusted vehicle command to operate the ego vehicle in the unstable, controllable operating range while maintaining recovery stability to transition to a safe operating range.

A non-transitory computer-readable medium having program code recorded thereon for a shared control, dynamic driving system is described. The program code is executed by a processor. The non-transitory computer-readable medium includes program code to determine a vehicle command requested by a vehicle operator of an ego vehicle. The non-transitory computer-readable medium also includes program code to predict the ego vehicle entering an unstable, controllable operating range if the vehicle command is performed. The non-transitory computer-readable medium further includes program code to adjust the vehicle command to maintain control of the ego vehicle in the unstable, controllable operating range. The non-transitory computer-readable medium also includes program code to perform an adjusted vehicle command to operate the ego vehicle in the unstable, controllable operating range while maintaining recovery stability to transition to a safe operating range.

A system for a shared control, dynamic driving system is described. The system includes a vehicle command module to determine a vehicle command requested by a vehicle operator of an ego vehicle. The system also includes an unsafe command prediction module to predict the ego vehicle entering an unstable, controllable operating range if the vehicle command is performed. The system further includes an adjusted vehicle command module to adjust the vehicle command to maintain control of the ego vehicle in the unstable, controllable operating range. The system also includes an adjusted command performance module to perform an adjusted vehicle command to operate the ego vehicle in the unstable, controllable operating range while maintaining recovery stability to transition to a safe operating range.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation using a system-on-a-chip (SOC) for a shared control, dynamic driving system, in accordance with aspects of the present disclosure.

FIG. 2 is a block diagram illustrating a software architecture that may modularize artificial intelligence (AI) functions for a shared, dynamic driving system of an autonomous agent, according to aspects of the present disclosure.

FIG. 3 is a diagram illustrating an example of a hardware implementation for a shared vehicle control, dynamic driving system, according to aspects of the present disclosure.

FIGS. 4A-4B are block diagrams illustrating a vehicle configured with a shared control, dynamic driving system, according to aspects of the present disclosure.

FIG. 5 is a diagram illustrating a vehicle model used for a nonlinear model predictive control (NMPC), as represented by a single-track dynamic bicycle model in a curvilinear coordinate system, according to various aspects of the present disclosure.

FIG. 6 is a graph illustrating a maximum phase recovery envelope (MPRE) relative to a stability handling envelope, according to various aspects of the present disclosure.

FIG. 7 illustrates a graph representing a vehicle state trajectory, in which a dashed line in a third row refers to track bounds, and a bottom row corresponds to a current of steering motor, according to various aspects of the present disclosure.

FIG. 8 illustrates trajectory comparison graphs between manual driving and shared control, according to various aspects of the present disclosure.

FIGS. 9A and 9B illustrate box plots of violation metrics, in which a line inside the box shows the median value, the box shows the quartile range, and the line outside the box shows the minimum and maximum values, according to various aspects of the present disclosure.

FIGS. 10A and 10B are graphs illustrating an intervention analysis, in which a magnitude of intervention i_{δ} and iᵣ as well as counter steering and engine torque suppression are shown, according to various aspects of the present disclosure.

FIGS. 11A and 11B illustrate a novice drifter utilizing the limits of a vehicle stability envelope and environmental constraints, including a roadwheel difference and an engine torque difference, according to various aspects of the present disclosure.

FIGS. 12A and 12B further illustrate a haptic shared control approach that respects safe driver commands, but intervenes when an unsafe driver command is detected, according to various aspects of the present disclosure.

FIG. 13 is a flowchart illustrating a method for a shared control, dynamic driving system, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

The National Highway Traffic Safety Administration (“NHTSA”) has defined different “levels” of autonomous vehicles (e.g., Level 0, Level 1, Level 2, Level 3, Level 4, and Level 5). These various levels of autonomous vehicles may provide a safety system that improves driving of a vehicle. For example, in a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle. The set of ADAS features installed in the autonomous vehicle may be a lane centering assistance system, a lane departure warning system, and/or a brake assistance system and, in some configurations, intervene automatically in a guardian-mode as part of a shared control system.

In particular, a set of advanced driver assistance system features may include an electric stability control (ESC) system. ESC systems are a type of shared control system that stabilizes vehicles under a restrictive target yaw rate where rear tire forces are not saturated. In some cases, this constraint is designed to keep the vehicle within a region referred to as a stable handling envelope (SHE) region, which is an open-loop stable region, in which ordinary drivers can easily drive as intended. Many shared control research studies have been conducted within this region for practical advanced driver assistance systems as this simplifies controller design and keeps the vehicle in an easier to control region where unstable dynamics can be avoided.

In shared control systems, both driver intention estimation and vehicle modeling are important. Some approaches prepare an advanced driver model and optimize it with an accurate long-term prediction of the future. As an example, vehicle modeling may represent the driver as a fuzzy-linear-quadratic regulator (LQR) model and incorporates the fuzzy-LQR model into the planning process to perform shared control for obstacle avoidance. This vehicle modeling representation of the driver as a fuzzy-LQR model improved vehicle dynamics predictions by modeling nonlinear dynamics with fuzzy logic. For example, a deep recurrent neural network was used to elaborately model the driver's intention and perform shared control to assist in lane keeping and lane changing.

Other approaches model only the driver's most recent intention and updates the driver's intention and control plan in high frequency. For example, other approaches achieve safety by restricting the vehicle to a stability envelope and an environmental envelope, and seamlessly determine intervention by balancing cost functions through model predictive control (MPC). Balancing cost through MPC has been applied to assist in obstacle avoidance and extended to provide predictive haptic feedback for human drivers. For example, nonlinear dynamics are incorporated to model rear tire saturation during double lane change maneuvers with online successive linearizations, while maintaining the vehicle in an open loop stable region. When considering shared control outside the open-loop stable region, accurate long-term predictions of the driver's intention is challenging due to potential variance in driver re-sponses since ordinary drivers rarely experience the unstable region under normal situations.

Nevertheless, maintaining vehicle operation with the noted SHE region comes with a sacrifice; namely, a trade-off of the agility of the vehicle for stability and safety. For example, expert-level, drifting maneuvers cannot be performed under conventional ESC systems because such driving maneuvers fall outside the SHE region. Yet professional drivers can confidently control agile maneuvers in drifting conditions of regions outside the region enforced by ESC systems. It is important that these regions are not neglected, such that a vehicle can utilize its full capabilities should a situation arise that involves expert driving maneuvers, such as drifting.

Various aspects of the present disclosure are directed to shared control beyond the typical ESC's operational region (e.g., the SHE region) to expand the practical options available to ordinary drivers. Various aspects of the present disclosure extends a stability envelope and vehicle models to manage an open-loop unstable region. Some aspects of the present disclosure are directed to a nonlinear model predictive control (NMPC) formulation that extends the envelope of vehicle stability from an open-loop stable region to an unstable, controllable region, which may be referred to as a maximum phase recovery envelope (MPRE). These aspects of the present disclosure incorporate nonlinear vehicle and tire dynamics as well as wheel-speed dynamics in a vehicle model that is extended to manage an open-loop unstable, yet still controllable, drifting regime. Additionally, a novel cost design incorporates the MPRE, track bounds, and spin-out constraints to ensure safety. Circular drift experiments are performed on a full-scale modified vehicle demonstrating the ability of the controller to enhance driver skill by following driver commands if safe, yet augmenting commands should the driver input yield constraint violation.

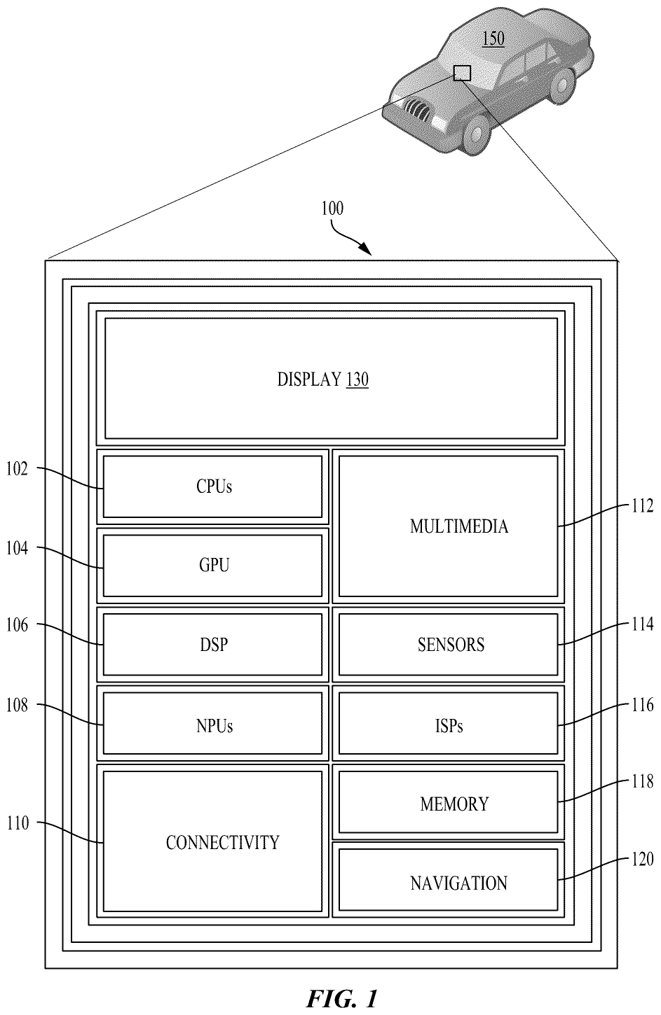

FIG. 1 illustrates an example implementation of the aforementioned system and method for a shared control, dynamic driving system using a system-on-a-chip (SOC) 100 of a vehicle 150. The SOC 100 may include a single processor or multi-core processors (e.g., a central processing unit (CPU) 102), in accordance with certain aspects of the present disclosure. Variables, system parameters associated with a computational device, delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, unlicensed WiFi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risk Machine (ARM) instruction set or the like. In another aspect of the present disclosure, the SOC 100 may be a server computer in communication with the vehicle 150. In this arrangement, the vehicle 150 may include a processor and other features of the SOC 100. In this aspect of the present disclosure, instructions loaded into a processor (e.g., CPU 102) or the NPU 108 of the vehicle 150 may include program code to extend a vehicle driving envelope to an unstable, controllable envelope MPRE, which is defined by a larger area and sideslip to support higher vehicle agility. For example, the MPRE (maximum phase recovery envelope) may refer to a boundary region in which maximum counter-steering can recover a vehicle state into the SHE region.

The instructions loaded into a processor (e.g., CPU 102) may also include program code to determine a vehicle command requested by a vehicle operator of an ego vehicle. The instructions loaded into a processor (e.g., CPU 102) may also include program code to predict the ego vehicle entering an unstable, controllable operating range if the vehicle command is performed. The instructions loaded into a processor (e.g., CPU 102) may also include program code to adjust the vehicle command to maintain control of the ego vehicle in the unstable, controllable operating range. The instructions loaded into a processor (e.g., CPU 102) may also include program code to perform an adjusted vehicle command to operate the ego vehicle in the unstable, controllable operating range while maintaining recovery stability to transition to a safe operating range.

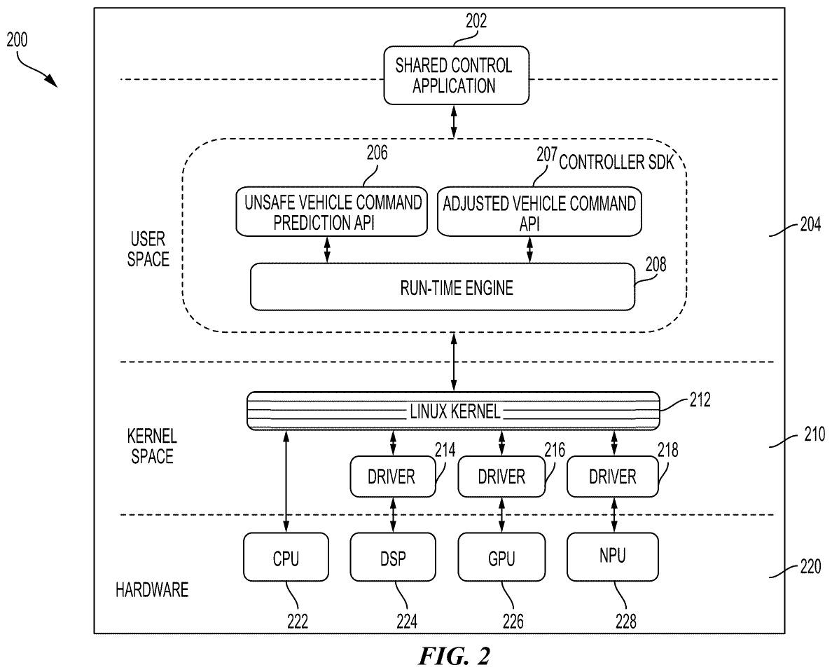

FIG. 2 is a block diagram illustrating a software architecture 200 that may modularize artificial intelligence (AI) functions for a shared control, dynamic driving system, according to aspects of the present disclosure. Using the architecture, a shared control application 202 may be designed such that it may cause various processing blocks of a system-on-a-chip (SOC) 220 (e.g., a CPU 222, a DSP 224, a GPU 226, and/or an NPU 228) to perform supporting computations during run-time operation of the shared control application 202. While FIG. 2 describes the software architecture 200 for shared vehicle control features, it should be recognized that shared control, expert-level driving skill features are not limited to autonomous agents. According to aspects of the present disclosure, an attention-based agent interaction system is applicable to any vehicle type, provided the vehicle is equipped with appropriate functions of an advanced driver assistance system (ADAS).

The shared control application 202 may be configured to call functions defined in a user space 204 that may, for example, provide for shared vehicle control services. The shared control application 202 may make a request to execute program code associated with a library defined in an unsafe vehicle command prediction application programming interface (API) 206 to predict an ego vehicle entering an unstable, controllable operating range if a vehicle command requested by a vehicle operator of the ego vehicle is performed. The shared control application 202 may also make a request to execute program code associated with a library defined in an adjusted vehicle command API 207 to adjust the vehicle command to maintain control of the ego vehicle in the unstable, controllable operating range. In response, the adjusted vehicle command is performed to operate the ego vehicle in the unstable, controllable operating range while maintaining recovery stability to transition to a safe operating range.

A run-time engine 208, which may be compiled code of a runtime framework, may be further accessible to the shared control application 202. The shared control application 202 may cause the run-time engine 208, for example, to take actions for communicating with a vehicle operator. When the vehicle operator begins to interact with a vehicle interface, the run-time engine 208 may in turn send a signal to an operating system 210, such as a Linux Kernel 212, running on the SOC 220. FIG. 2 illustrates the Linux Kernel 212 as software architecture for implementing shared vehicle control, dynamic driving of the vehicle. It should be recognized, however, that aspects of the present disclosure are not limited to this exemplary software architecture. For example, other kernels may be used to provide the software architecture to support the shared vehicle control functionality using the adjust vehicle command functionality to provide improved shared vehicle control functionality outside a safe operating range.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, a nonlinear model predictive control may be configured to run on a combination of processing blocks, such as the CPU 222 and the GPU 226, or may be run on the NPU 228 if present.

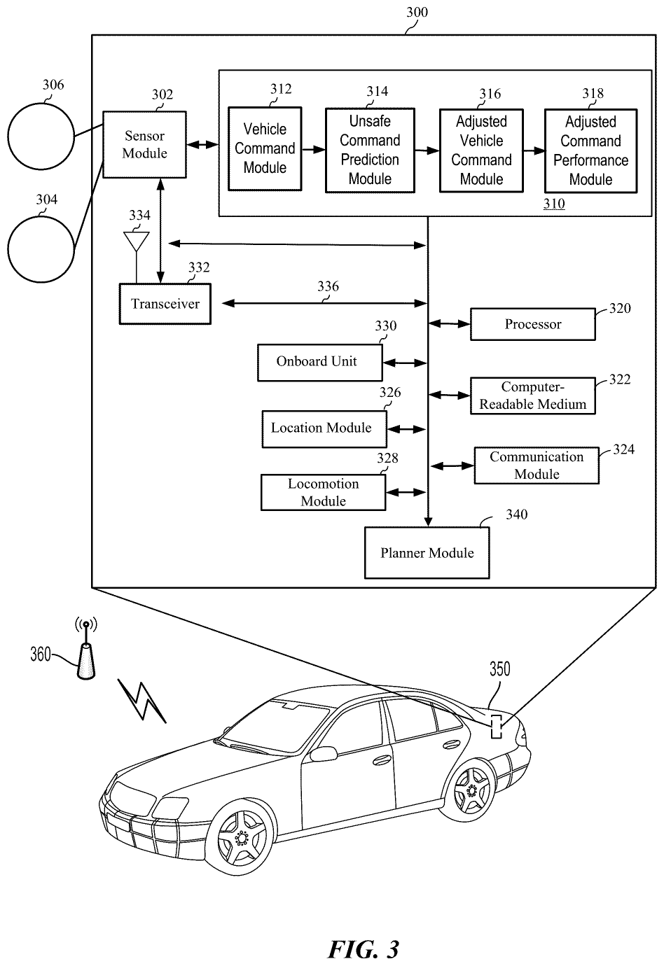

FIG. 3 is a diagram illustrating an example of a hardware implementation for a shared vehicle control, dynamic driving system 300, according to aspects of the present disclosure. The shared vehicle control, dynamic driving system 300 may be configured to support shared vehicle control that provides ordinary drivers with expert level driving skills, such as performing drifting during operation of a car 350. The shared vehicle control, dynamic driving system 300 may be a component of a vehicle or other non-autonomous device (e.g., non-autonomous vehicles). For example, as shown in FIG. 3, the shared vehicle control, dynamic driving system 300 is a component of the car 350.

Aspects of the present disclosure are not limited to the shared vehicle control, dynamic driving system 300 being a component of the car 350. Other devices, such as a bus, motorcycle, or other like non-autonomous vehicle, are also contemplated for implementing the shared vehicle control, dynamic driving system 300. In this example, the car 350 may be autonomous or semi-autonomous; however, other configurations for the car 350 are contemplated, such as an advanced driver assistance system (ADAS).

The shared vehicle control, dynamic driving system 300 may be implemented with an interconnected architecture, such as a controller area network (CAN) bus, represented by an interconnect 336. The interconnect 336 may include any number of point-to-point interconnects, buses, and/or bridges depending on the specific application of the shared vehicle control, dynamic driving system 300 and the overall design constraints. The interconnect 336 links together various circuits including one or more processors and/or hardware modules, represented by a sensor module 302, a shared vehicle controller 310, a processor 320, a computer-readable medium 322, a communication module 324, a location module 326, a locomotion module 328, an onboard unit 330, and a planner module 340. The interconnect 336 may also link various other circuits such as timing sources, peripherals, voltage regulators, and power management circuits, which are well known in the art, and therefore, will not be described further.

The shared vehicle control, dynamic driving system 300 includes a transceiver 332 coupled to the sensor module 302, the shared vehicle controller 310, the processor 320, the computer-readable medium 322, the communication module 324, the location module 326, the locomotion module 328, the onboard unit 330, and the planner module 340. The transceiver 332 is coupled to antenna 334. The transceiver 332 communicates with various other devices over a transmission medium. For example, the transceiver 332 may receive commands via transmissions from a user or a connected vehicle. In this example, the transceiver 332 may receive/transmit vehicle-to-vehicle traffic state information for the shared vehicle controller 310 to/from connected vehicles within the vicinity of the car 350.

The shared vehicle control, dynamic driving system 300 includes the processor 320 coupled to the computer-readable medium 322. The processor 320 performs processing, including the execution of software stored on the computer-readable medium 322 to provide functionality according to the disclosure. The software, when executed by the processor 320, causes the shared vehicle control, dynamic driving system 300 to predict the car 350 entering an unstable, controllable operating range if a vehicle command requested by a vehicle operator of the car 350 is performed. The shared vehicle control, dynamic driving system 300 is further caused to adjust the vehicle command to maintain control of the car 350 in the unstable, controllable operating range. The computer-readable medium 322 may also be used for storing data that is manipulated by the processor 320 when executing the software.

The sensor module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images of the vehicle operator. The second sensor 304 may be a ranging sensor, such as a light detection and ranging (LIDAR) sensor or a radio detection and ranging (RADAR) sensor for capturing an external vehicle environment. Of course, aspects of the present disclosure are not limited to the aforementioned sensors as other types of sensors (e.g., GPS and/or IMU) are also contemplated for either of the first sensor 306 or the second sensor 304.

The measurements of the first sensor 306 and the second sensor 304 may be processed by the processor 320, the sensor module 302, the shared vehicle controller 310, the communication module 324, the location module 326, the locomotion module 328, the onboard unit 330, and/or the planner module 340. In conjunction with the computer-readable medium 322, the measurements of the first sensor 306 and the second sensor 304 are processed to implement the functionality described herein. In one configuration, the data captured by the first sensor 306 and the second sensor 304 may be transmitted to a connected vehicle via the transceiver 332. The first sensor 306 and the second sensor 304 may be coupled to the car 350 or may be in communication with the car 350.

The location module 326 may determine a location of the car 350. For example, the location module 326 may use a global positioning system (GPS) to determine the location of the car 350. The location module 326 may implement a dedicated short-range communication (DSRC)-compliant GPS unit. A DSRC-compliant GPS unit includes hardware and software to make the car 350 and/or the location module 326 compliant with one or more of the following DSRC standards, including any derivative or fork thereof: EN 12253:2004 Dedicated Short-Range Communication-Physical layer using microwave at 5.8 GHz (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

The communication module 324 may facilitate communications via the transceiver 332. For example, the communication module 324 may be configured to provide communication capabilities via different wireless protocols, such as 6G, 5G NR, WiFi, long term evolution (LTE), 4G, 3G, etc. The communication module 324 may also communicate with other components of the car 350 that are not modules of the shared vehicle control, dynamic driving system 300. The transceiver 332 may be a communications channel through a network access point 360. The communications channel may include DSRC, 6G, 5G NR, LTE, LTE-D2D, mmWave, WiFi (infrastructure mode), WiFi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, WiFi (infrastructure mode), WiFi (ad-hoc mode), visible light communication, TV white space communication, and satellite communication. The network access point 360 may also include a mobile data network that may include 3G, 4G, 5G NR, 6G, LTE, LTE-V2X, LTE-D2D, VoLTE, or any other mobile data network or combination of mobile data networks. Further, the network access point 360 may include one or more IEEE 802.11 wireless networks.

The shared vehicle control, dynamic driving system 300 also includes the planner module 340 for planning a route and controlling the locomotion of the car 350, via the locomotion module 328 for autonomous operation of the car 350. In one configuration, the planner module 340 may override a user input when the user input is expected (e.g., predicted) to cause a collision according to an autonomous level of the car 350. The modules may be software modules running in the processor 320, resident/stored in the computer-readable medium 322, and/or hardware modules coupled to the processor 320, or some combination thereof.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. These distinct levels of autonomous vehicles are described briefly below.

Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks but is still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the district where the vehicle is located).

A highly autonomous vehicle (“HAV”) is an autonomous vehicle that is Level 3 or higher. Accordingly, in some configurations the car 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The shared vehicle controller 310 may be in communication with the sensor module 302, the processor 320, the computer-readable medium 322, the communication module 324, the location module 326, the locomotion module 328, the onboard unit 330, the transceiver 332, and the planner module 340. In one configuration, the shared vehicle controller 310 receives sensor data from the sensor module 302. The sensor module 302 may receive the sensor data from the first sensor 306 and the second sensor 304. According to aspects of the present disclosure, the sensor module 302 may filter the data to remove noise, encode the data, decode the data, merge the data, extract frames, or perform other functions. In an alternate configuration, the shared vehicle controller 310 may receive sensor data directly from the first sensor 306 and the second sensor 304 to determine, for example, input traffic data images.

In shared control systems, both driver intention estimation and vehicle modeling are important. Some approaches prepare an advanced driver model and optimize the model with an accurate long-term prediction of the future. As an example, a vehicle modeling representation of the driver as a fuzzy-linear-quadratic regulator (LQR) model improved vehicle dynamics predictions by modeling nonlinear dynamics with fuzzy logic. Other approaches model the driver's most recent intention and update the driver's intention and control plan in high frequency. For example, other approaches achieve safety by restricting the vehicle to a stability envelope and an environmental envelope, and seamlessly determine intervention by balancing cost functions through model predictive control (MPC).

Balancing cost through MPC has been applied to assist in obstacle avoidance and may be extended to provide predictive haptic feedback for human drivers. When considering shared control outside the open-loop stable region, accurate long-term predictions of the driver's intention is challenging due to potential variance in driver re-sponses since ordinary drivers rarely experience the unstable region under normal situations. Nevertheless, maintaining vehicle operation with a stable handling envelope (SHE) region comes with a sacrifice; namely, a trade-off of the agility of the vehicle for stability and safety. For example, expert level drifting maneuvers cannot be performed under conventional systems because such driving maneuvers fall outside the SHE region. Yet professional drivers can confidently control agile maneuvers in drifting conditions of regions outside the SHE region enforced by conventional systems. It is desired that these regions are not neglected, such that a vehicle can utilize its full capabilities should a situation arise that involves expert driving maneuvers, such as a drifting maneuver.

Various aspects of the present disclosure are directed to shared control beyond the typical SHE operational region to expand the practical options available to ordinary drivers. Various aspects of the present disclosure extend a stability envelope and vehicle models to manage an open-loop unstable region. Some aspects of the present disclosure are directed to a nonlinear model predictive control (NMPC) formulation that extends the envelope of vehicle stability from an open-loop stable region to an unstable, controllable region, which may be referred to as a maximum phase recovery envelope (MPRE). These aspects of the present disclosure incorporate nonlinear vehicle and tire dynamics as well as wheel-speed dynamics in a vehicle model that is extended to manage an open-loop unstable, yet still controllable, drifting regime. Additionally, a novel cost design incorporates the MPRE, track bounds, and spin-out constraints to ensure safety. Circular drift experiments are performed on a full-scale modified vehicle demonstrating the ability of the controller to enhance driver skill by following driver commands if safe, yet augmenting commands should the driver input yield constraint violation.

In these aspects of the present disclosure, the shared vehicle control, dynamic driving system 300 is configured to extend a vehicle driving envelope of the car 350 to an unstable, controllable envelope MPRE, which is defined by a larger area and sideslip to support higher vehicle agility. For example, the MPRE (maximum phase recovery envelope) may refer to a boundary region in which maximum counter-steering can recover a vehicle state of the car into the SHE region.

As shown in FIG. 3, the shared vehicle control, dynamic driving system 300 includes the shared vehicle controller 310 that includes a vehicle command module 312, an unsafe command prediction module 314, an adjusted vehicle command module 316, and an adjusted command performance module 318. The unsafe command prediction module 314, the adjusted vehicle command module 316, and the adjusted command performance module 318 may be configured using nonlinear model predictive control. The shared vehicle controller 310 is not limited to nonlinear model predictive control.

The vehicle command module 312 is configured to determine a vehicle command requested by a vehicle operator of an ego vehicle. In response to the requested vehicle command, the unsafe command prediction module 314 is configured to predict the ego vehicle entering an unstable, controllable operating range if the requested vehicle command is performed. In response to detection of an unsafe vehicle command, the adjusted vehicle command module 316 is configured to adjust the vehicle command to prevent the ego vehicle from entering in the unsafe region. Additionally, the adjusted command performance module 318 is configured to perform an adjusted vehicle command to operate the ego vehicle in the unstable, controllable operating range while maintaining recovery stability to transition to a safe operating range.

As described in further detail below, circular drifting experiments with a full-scale vehicle demonstrate the ability of the shared vehicle controller 310 to follow driver commands in safe states, while augmenting the driver commands to avoid situations of track bound violations and spin-out when drifting in a circle by intervening automatically in a guardian-mode. Various aspects of the present disclosure may be implemented in an agent, such as a vehicle. The vehicle may operate in either an autonomous mode, a semi-autonomous mode, or a manual mode. In some examples, the vehicle may switch between operating modes.

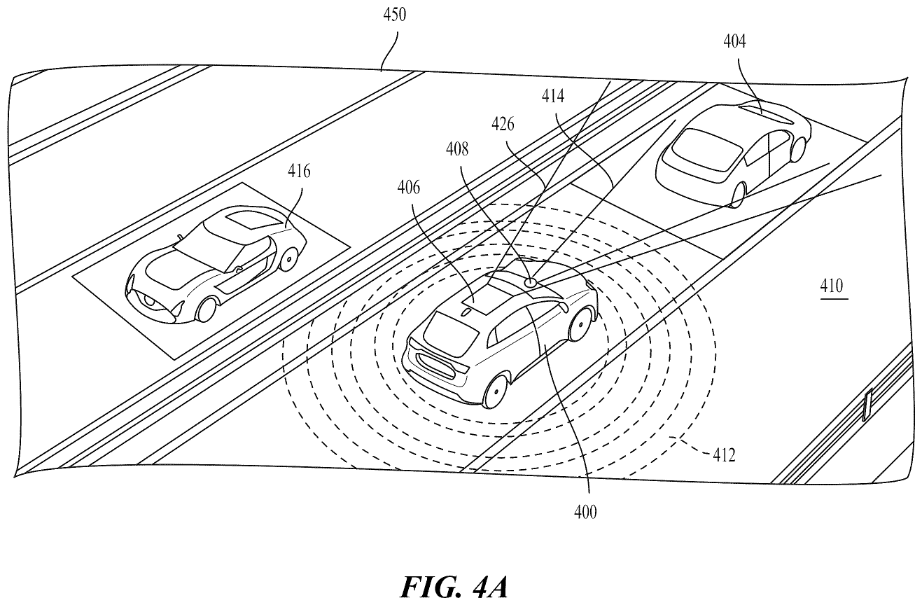

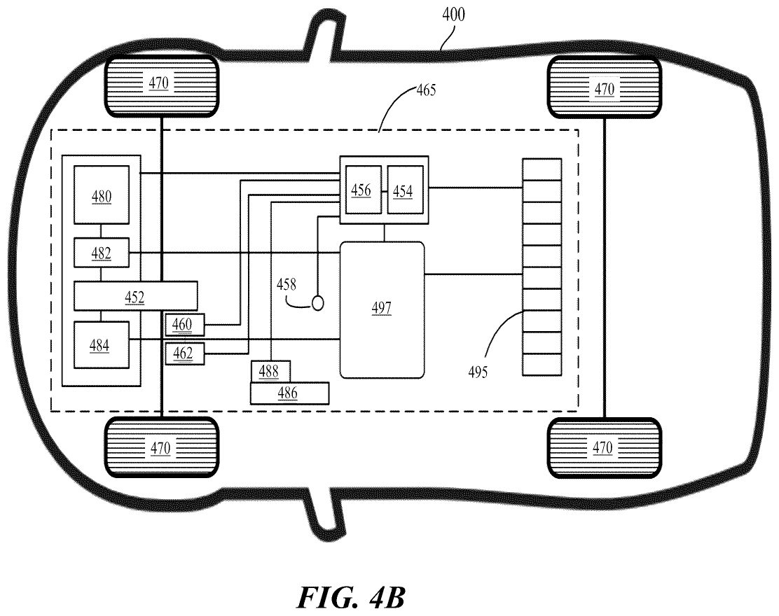

FIGS. 4A-4B are block diagrams illustrating a vehicle configured with a shared control, dynamic driving system, according to aspects of the present disclosure.

FIG. 4A is a diagram illustrating an example of a vehicle 400 in an environment 450, in accordance with various aspects of the present disclosure. In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system (e.g., the sensor module 302). Other sensors, such as radar and/or ultrasound, are also contemplated. Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera's 408 field of view 414. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward-facing field of view, such as the 2D camera's 408 field of view 414 and/or the 2D sensor's 406 field of view 426.

The 2D image captured by the 2D camera 408 includes a 2D image of the first vehicle 404, as the first vehicle 404 is in the 2D camera's 408 field of view 414. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream 424 and may be implemented using nonlinear model predictive control.

The information obtained from the LIDAR sensor 406 and the 2D camera 408 may be used to evaluate a driving environment. In some examples, the information obtained from the LIDAR sensor 406 and the 2D camera 408 may identify whether the vehicle 400 is at an intersection or a crosswalk. Additionally, or alternatively, the information obtained from the LIDAR sensor 406 and the 2D camera 408 may identify whether one or more dynamic objects, such as pedestrians, are near the vehicle 400.

FIG. 4B is a diagram illustrating an example of a vehicle 400, in accordance with various aspects of the present disclosure. It should be understood that various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and an accelerometer 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. The MGs 482 and 484 can also output torque to the transmission 452. The engine 480 and the MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The accelerometer 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, the engine 480 should provide a fraction of the applied torque to the wheels 470 while one or both of the MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle 400. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456, so as to convert direct current (DC) power from the battery 495 to alternating current (AC) power and supply the AC power to the MGs 482 and 484. In some examples, a first MG 482 may be driven by electric power generated by a second MG 484. It should be understood that in embodiments where MGs 482 and 484 are DC motors, no inverter is required. The inverter 497, in conjunction with a converter assembly, may also accept power from one or more of the MGs 482 and 484 (e.g., during engine charging), convert this power from AC back to DC, and use this power to charge the battery 495 (hence the name, motor generator). The ECU 456 may control the inverter 497, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting, during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current as a result of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both of the MGs 482 and 484. When the battery 495 is implemented using one or more batteries, the batteries can include, for example, nickel metal hydride batteries, lithium-ion batteries, lead acid batteries, nickel cadmium batteries, lithium-ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

In various aspects of the present disclosure, implementation of the shared vehicle control, dynamic driving system 300 of FIG. 3 in the vehicle 400 expands the shared control paradigm for autonomous vehicles (e.g., the vehicle 400) to include an open-loop unstable region. This expansion of the shared control paradigm improves safety in extreme vehicle conditions, such as tire saturation from encountering low friction or from emergency lane changes. While conventional approaches may sacrifice agility for stability by restricting the vehicle domain to operate in an open-loop stable regime, the shared vehicle control, dynamic driving system 300 expands existing shared control approaches to ensure safety outside the open-loop stable region.

In various aspects of the present disclosure, the shared vehicle controller 310 is implemented using a nonlinear model predictive control framework that balances a cost to follow a driver's command with a cost for safety. According to this balance, the shared vehicle controller 310 does not disturb the driver in safe states and seamlessly limits intervention to situations that involve dangerous states. Specifically, the shared vehicle controller 310 implements a novel cost function that is formulated to incorporate driver intent, while ensuring safety through costs associated with a maximum phase recovery envelope and track bounds.

### I. Vehicle Model

### A. Bicycle Model

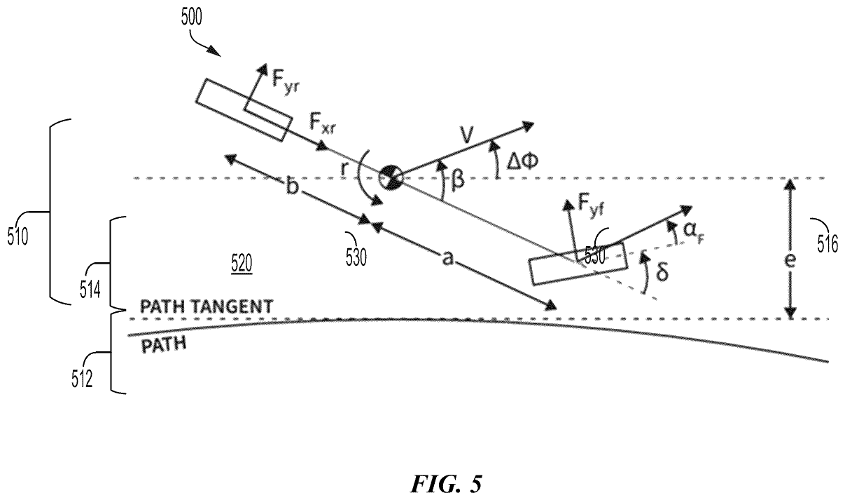

FIG. 5 is a diagram illustrating a vehicle model used for a nonlinear model predictive control (NMPC), as represented by a single-track dynamic bicycle model in a curvilinear coordinate system, according to various aspects of the present disclosure. In various aspects of the present disclosure, a shared vehicle controller ensures sufficient model fidelity for drifting through a nonlinear bicycle model that incorporates a nonlinear tire model and wheel speed dynamics. FIG. 5 illustrates a vehicle model 500 used for an NMPC that is represented by the single-track dynamic bicycle model in a curvilinear coordinate system. For example, the vehicle state is constructed as:

$$x = [ \begin{matrix}r \\ V \\ β \\ {ω}_{r} \\ e \\ Δϕ \\ δ \\ τ\end{matrix} ] = [ \begin{matrix}Yaw rate \\ Velocity \\ Sideslip \\ Real wheelspeed \\ Lateral error \\ Course error \\ Roadwheel angle \\ Engine torque\end{matrix} ] . \qquad ( 1 )$$

The control inputs are defined as:

$$u = [ \begin{matrix}\dot{δ} \\ \dot{τ}\end{matrix} ] [ \begin{matrix}Roadwheel angle rate \\ Engine torque rate .\end{matrix} ] \qquad ( 2 )$$

The state derivatives are given as:

$$\dot{x} = [ \begin{matrix}\frac{α {F}_{yf} cos δ + α {F}_{xf} sin δ - {bF}_{yr}}{{I}_{z}} \\ \frac{- {F}_{yf} sin ( δ - β ) + {F}_{xf} cos ( δ - β ) + {F}_{yr} sin β + {F}_{xr} cos β}{m} \\ \frac{{F}_{yf} cos ( δ - β ) + {F}_{xf} sin ( δ - β ) + {F}_{yr} cos β - {F}_{xr} sin β}{mV} - r \\ \frac{{r}_{w} ( {G}_{τ} - {F}_{xr} {r}_{w}}{{I}_{w}} \\ V sin ( Δϕ ) \\ \dot{ϕ} = {κ}_{ref} \frac{V cos ( Δϕ )}{1 - {κ}_{ref} e} \\ \dot{δ} \\ \dot{τ}\end{matrix} ] \qquad ( 3 )$$

where \dot{ϕ}\dot{β}+\dot{r}, α and b are the distances from the center of gravity to the front and rear axles, r_{w} is the tire radius, G is the ratio from engine to wheel torque, m is the vehicle mass, and I_{z} and I_{w} are the inertia of the vehicle and wheel, respectively. F_{x(f,r)} and F_{y(f,r)} denote the longitudinal and lateral tire forces for the front and rear tires, respectively. κ_{ref} is the curvature of the reference trajectory and j is the rotation rate of the vehicle's velocity vector.

### B. Tire Model

In various aspects of the present disclosure, a tire model models a tire as a coupled slip Fiala brush tire model. In this example, longitudinal and lateral tire force is written as:

$$[ \begin{matrix}{F}_{y} \\ {F}_{x}\end{matrix} ] = {F}_{total} [ \frac{\frac{- tan α}{σ}}{\frac{κ}{σ}} ] , \qquad ( 4 )$$

where α, κ, and σ are the lateral, longitudinal and combined slip, respectively:

$${α}_{f} = arctan \frac{V sin β + a r}{V cos β} - δ {κ}_{f} = 0 {α}_{r} = arctan \frac{V sin β - b r}{V cos β} {κ}_{r} = \frac{R ω - V cos β}{V cos β} σ = \sqrt{{tan}^{2} α + {κ}^{2}} . \qquad ( 5 )$$

The subscripts f and r denote the front tire and rear tire, respectively. These aspects of the present disclosure assume that the vehicle 400 is rear-wheel drive, the brake torques are zero for the particular drifting scenario in the subsequent experiment to simplify the problem and thus the front longitudinal slip κ_{f}=0. The total tire force is calculated as:

$${F}_{total} = \{ \begin{matrix}{C}_{f} σ - \frac{{C}_{f}^{2} {σ}^{2}}{3 μ {F}_{z}} + \frac{{C}_{f}^{3} {σ}^{3}}{27 {( μ {F}_{z} )}^{2}} & \vert σ \vert < {σ}_{sl} \\ μ {F}_{z} & \vert σ \vert > {σ}_{sl}\end{matrix}$$

where C_{f} is the cornering stiffness, μ is the coefficient of friction, F_{z} is the normal load, and σₛₜ is the maximum combined slip where tire force saturation occurs: σₛₜ=arctan(3 μF_{z}/C_{f}).

### II. Envelope Definition

### A. Maximum Phase Recovery Envelope

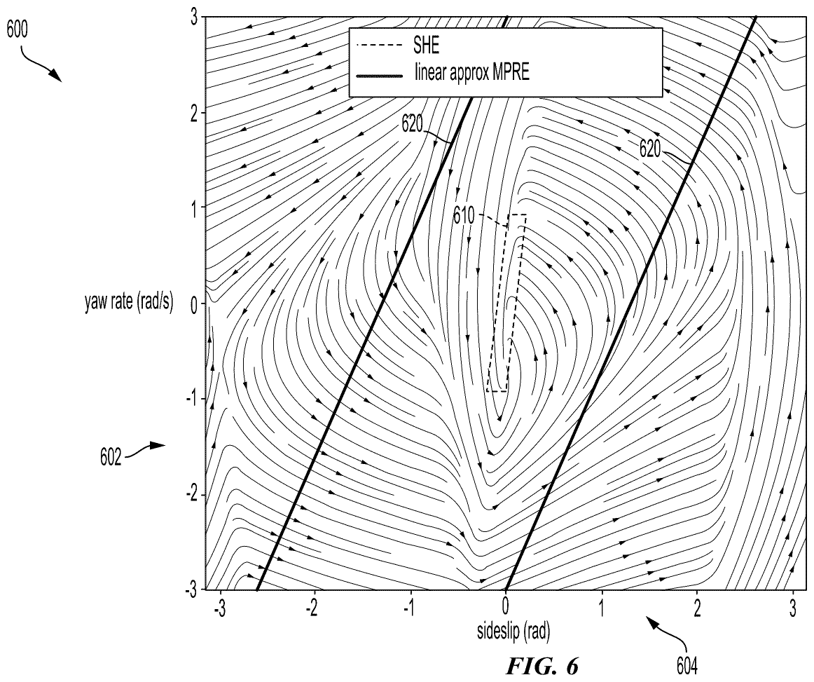

FIG. 6 is a graph illustrating a maximum phase recovery envelope (MPRE) region relative to a stability handling envelope (SHE) region 610, according to various aspects of the present disclosure. Conventional shared control systems rely on the SHE region 610 as a vehicle stability envelope, which restricts the vehicle state to a state space where all tires are not saturated, and the vehicle is open-loop stable. Various aspects of the present disclosure extend the SHE region 610 to an unstable, controllable envelope of the MPRE region 620, which is defined by a larger yaw rate 602 and sideslip 604 to allow higher agility, as shown in an MPRE graph 600. As described, the MPRE region 620 is defined as the boundary region where maximum counter-steering can recover the vehicle state into the SHE region 610.

As shown in FIG. 6, an approximation of the MPRE region 620 is shown relative to the SHE region 610, which is enclosed in the MPRE region 620. In this example, the MPRE graph 600 shows a phase portrait drawn with a fixed velocity and roadwheel angle (e.g., V=10 m/s and δ=−0.7 rad). The vehicle state moves along with the flow with the fixed velocity V and the roadwheel angle S. Additionally, FIG. 6 shows a portion of the MPRE border. This phase portrait is drawn with assumption of velocity (e.g., V=10 m/s) as the expected maximum speed during circular drifting and roadwheel angle (e.g., (δ−0.7 rad) as a conservative maximum counter-steering angle.

In this example, the vehicle state moves along the arrow on the plot of the MPRE graph 600, with the fixed velocity V and roadwheel angle S. For example, a left portion of the MPRE region 620 is the separatrix on the plot which divides the flow going into the SHE region 610 and the flow going to spin-out (β<−π) (e.g., the unstable region). In this example, a right portion can be drawn with an opposite maximum counter-steering. Additionally, the MPRE region 620 has a larger state space and allows the vehicle 400 to use more control options than the SHE region 610. To prevent excessive computational complexity in the MPC formulation described in Sec. III, the MPRE region 620 is constructed by a linear approximation, shown in FIG. 6. A left line of the MPRE region 620 is defined as:

$$r = {MPRE}_{p , q} ( β ) = p β + q . \qquad ( 6 )$$

From symmetry, a right line of the MPRE region 620 is defined as r=MPRE_{p,-q} (β). The upper and lower bounds of the MPRE region 620 are not used because the subsequent circular drifting experiment would not reach the upper and lower bounds of the MPRE region 620. The parameters of the straight line are determined based on the phase portrait (e.g., p=2.3 and q=3.0).

### B. Environmental Envelope

The environmental constraints are defined by the inner track bound eₘᵢₙ and the outer track bound eₘₐₓ. This envelope prevents exceeding the imposed course track bounds (e.g., a track bounds violation).

### III. MPC Formulation for Shared Control

The model predictive control (MPC) shared controller address in this work is designed to follow a driver's commands and intervene in steering and engine torque only when necessary to ensure safety. In various aspects of the present disclosure, the amount of intervention is determined seamlessly through the MPC by balancing the cost for following the driver and the cost for safety. The dynamics are expressed in spatial terms relative to the reference trajectory's curvilinear coordinate (s, e) to encode the reference path and trajectory states efficiently:

$$\frac{dx}{ds} = \frac{1}{\dot{s}} \frac{dx}{dt} where \dot{s} = \frac{V cos Δϕ}{1 - {κ}_{ref} e} .$$

To ensure high integration accuracy in the first part of the horizon while maintaining an adequate lookahead distance, the horizon is constructed by a ds=0.01 m step, seven ds=0.5 m steps and twelve ds=1.5 m steps. The MPC formulation is implemented and solved, in which the MPC minimizes total cost J defined as:

$$J = {\sum }_{κ = 1}^{M} {J}_{follo {w}_{κ}} + {\sum }_{κ = 1}^{N} ( {J}_{{MPRE}_{κ}} + {J}_{{β}_{κ}} + {J}_{{α}_{f} , κ} + {J}_{{w}_{r} , κ} + {J}_{{CO}_{κ}} + {J}_{{ref}_{κ}} + {J}_{{\dot{δ}}_{κ}} + {J}_{\dot{τ}} ) + {J}_{F} , \qquad ( 7 )$$

where N is the planning horizon and M(≤N) is the maximum number of planning steps for the driver following cost. The MPC contains four primary cost functions, cost J_{follow}_{_{κ}} to follow driver intention, J_{MPRE}_{_{κ}} to prevent spin-out, J_{CO}_{_{κ}} to prevent course-out, and J_{ref}_{_{κ}} to track the reference drift trajectory which helps to accelerate convergence time and to guide the vehicle back into the safe region smoothly.

### A. Cost to Follow Driver's Intention

The cost function to follow a driver's intention is defined as:

$${J}_{follo {w}_{κ}} = {w}_{κ} ( {{Q}_{δ} ( {δ}_{MPC , κ} - {\hat{δ}}_{drv , κ} )}^{2} + {{Q}_{τ} ( {τ}_{MPC , κ} - {\hat{τ}}_{drv , κ} )}^{2} ) , \qquad ( 8 )$$

where Qₓ denotes the weight of a cost element, \hat{δ}_{drv} and \hat{τ}_{drv} are predicted driver's intentions for the roadwheel angle and engine torque, and w_{κ}=exp(−gk) is an exponential decay factor to prioritize near term predictions. Since predictions of a driver's intentions become less dependable for the future steps, w_{κ} is decayed along the planning steps; g is the gain parameter to control the magnitude of the weight decay. \hat{δ}_{drv,}_{_{κ}}−\hat{δ}_{drv} and \hat{τ}_{drv,κ}−\hat{τ}_{drv} are set as constant values along M steps for simplicity. \hat{δ}_{drv} is predicted by quadratic polynomial regression from five recent time steps and the measured δ as a 50 ms lookahead to mitigate steering delay caused by the MPC convergence time, while \hat{τ}_{drv} is set as the current requested engine torque calculated directly from the throttle pedal information to prevent prediction runaway. Since delay already exists between throttle pedal and engine torque activation, the delay on engine activation caused by the MPC computation is less noticeable than that on steering.

### B. Cost to Prevent Spin-Out and Course-Out

J_{MPRE}_{_{κ}} is designed to keep the vehicle within the MPRE to prevent spin-out. This soft constraint gives a large cost when the vehicle state crosses the MPRE boundary as:

$${J}_{{MPRE}_{κ}} = {Q}_{MPRE} ( {SoftPlus}_{{c}_{MPRE} , {d}_{M P R E}} ( {r}_{κ} - {MPRE}_{p , q} ( {β}_{κ} ) ) + {SoftPlus}_{{c}_{MPRE} , {d}_{MPRE}} ( {MPRE}_{p , - q} ( {β}_{κ} ) - {r}_{κ} ) ) , \qquad ( 9 )$$

where SoftPlus_{c,d}(x)=log(1+exp(c*x))/d. Instead of switching the cost function with if-else statements, the SoftPlus function is used to ensure continuous differentiability for gradient based optimization. Excessive sideslip is also penalized to prevent spin-out by J_{β}_{_{κ}}=Q_{β} SoftPlus_{c}_{_{β}}_{,d}_{_{β}}(β_{κ}−β_{threshold}). Lastly, small costs are imposed on the lateral slip angle of the front tire α_{f} and the rear wheel speed wᵣ to prevent saturation of the front tire forces and to help recover rear tire grip. These costs are given by J_{α}_{_{fκ}}=Q_{α}_{_{f}}α_{f,k}² and J_{w}_{_{r,k}}=Q_{w}_{ᵣ}w_{r,k}², respectively.

$$Cost to prevent course - out is defined in a similar manner as {J}_{MPRE} as {J}_{C {O}_{κ}} = {Q}_{CO} ( {SoftPlus}_{{c}_{track} , {d}_{track}} ( {e}_{κ} - {e}_{max} ) + {SoftPlus}_{{c}_{track} , {d}_{track}} ( {e}_{min} - {e}_{κ} ) ) .$$

### C. Cost to Follow Reference Drift Trajectory

J_{ref}_{_{κ}} is a tracking cost that facilitates convergence and smooth recovery to the safe state space. The cost function is defined as J_{ref}_{_{κ}}=Qₑe_{κ}²+Q_{Δφ}(Δφ_{κ})²+Q_{β}(β_{κ}=β_{ref})², where β_{ref}=−0.6 in the experiment of Sec. VI. To compensate for the finite length of the control horizon, an additional cost is applied for the terminal stability of lateral errors and sideslip. Specifically, stable first-order dynamics are applied at the terminal stage N as J_{N}=Q_{Nβ}(\dot{β}_{N}−\dot{β}_{des})²+Q_{Ne}(ė_{N}−ė_{des})², where \dot{β}_{des}=−κ_{β}(β−β_{ref}), ė_{des}=−κₑe_{ref}, κ_{β} and κₑ are time constraints.

### D. Cost to Prevent Sudden Actuation and Constraints

\dot{δ} and \dot{τ} are regulated to mitigate the risk of unexpected sudden vehicle behavior and avoid large torques on the driver's hand by J_{δ̅}_{_{κ}}=Q_{\dot{δ}}δ̅_{κ}² and J_{\dot{τ}}_{_{κ}}=Q_{\dot{τ}}\dot{τ}_{κ}². In addition to state transition constraints, safety constraints were imposed on hardware limits and actuation limits consistent with the vehicle capabilities and driver safety. The initial state, x₀, is set as the predicted state x_{lookahead} to account for the MPC computation time. Since the MPC optimization takes 20 ms on average, x_{lookahead} is predicted by propagating x₀ for 20 ms future through the vehicle model with engine torques in the previous solution and \hat{δ}_{drv}.

### V. Experimental Procedure

In various aspects of the present disclosure, drivers performed the task of trying to drift while keeping the vehicle's center of gravity within certain track bounds. In these experiments, the inner and outer circles of the track bounds were drawn on the pad and drivers performed left turning drifting using the circles as landmarks. The radius of inner, reference and outer circle was 6 m, 8 m, and 13 m, respectively. Only the first gear was used for the experiment. Two subjects participated in the experiment. Both subjects were novice drifters with little to no professional training. Testing consisted of two parts. First, the subjects (participant A and participant B) were asked to drift manually under the guidance of an experienced drifter to familiarize themselves with the vehicle and how to drift. After that, they moved on to the shared control experiment. Participant A tried 5 manual trials and 38 shared control trials, and participant B tried 17 trials for both manual driving and shared control. The shared control system was activated once the sideslip fell below −0.1. The experiment consisted of three evaluation items: following driver commands, preventing track bound violation, and preventing spin-out.

### VI. Results and Discussion

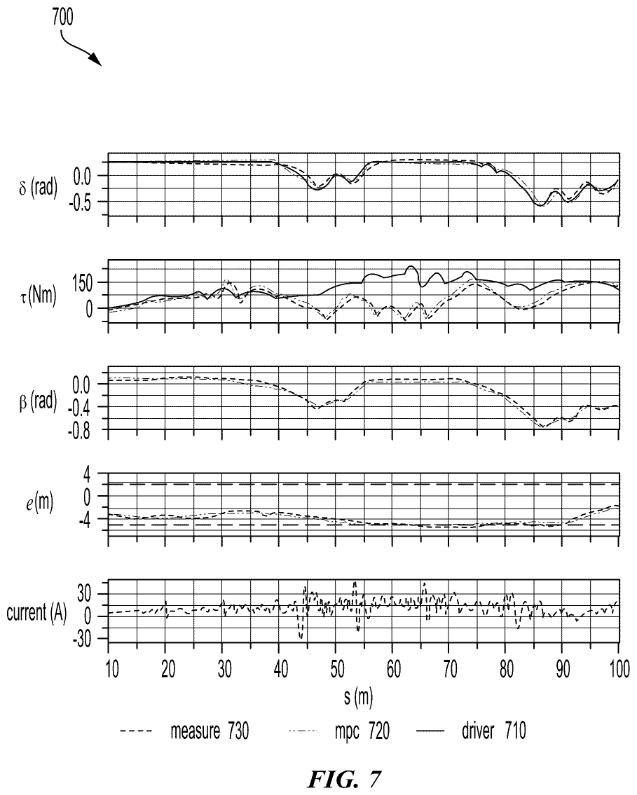

FIG. 7 illustrates a graph 700 representing a vehicle state trajectory, in which a dashed line in a third row refers to track bounds, and a bottom row corresponds to a current of steering motor, according to various aspects of the present disclosure. In this example, FIG. 7 shows the result on a driver following with participant A. The second row of the graph 700 shows a time series of engine torque. The first line is the engine torque requested by the driver 710, the second line is the executed plan of the model predictive control (MPC) 720, and the third line is the measured amount of engine torque 730. Additionally, a horizontal axis of the graph 700 represents a distance traveled along the reference circle.

In this example, engine torque 730 of the graph 700 shows that the controller followed the driver's request well when it was feasible (e.g., between s=10 and 40 m, and s=90 and 100 m). On the other hand, when the lateral error was large and there was a danger of course-out, or when the side slip was large and there was a danger of spin-out, the engine torque 730 was reduced from the driver's request to prevent the danger (e.g. between s=40 m and 90 m). As for steering, it is difficult to measure the requested steering by the driver 710 and the MPC 720 output independently because the steering is mechanically coupled. As an alternative, the current of the steering motor produced by a proportional derivative (PD) controller may be considered as the magnitude of intervention because it has linear relationship to the torque applied to the steering wheel. In this example, the current shown in the fourth row of the graph 700 was smoothed by moving average along 10 samplings in 200 Hz data for visibility. As shown in the fourth row of the graph 700, the current was weak under normal conditions so as not to disturb the driver's operation where intervention was not needed (between s=10 and 40 m), whereas large current was applied to bring back the vehicle within the track bounds when the vehicle was about to go outside the track bounds (between s=40 and 90 m).

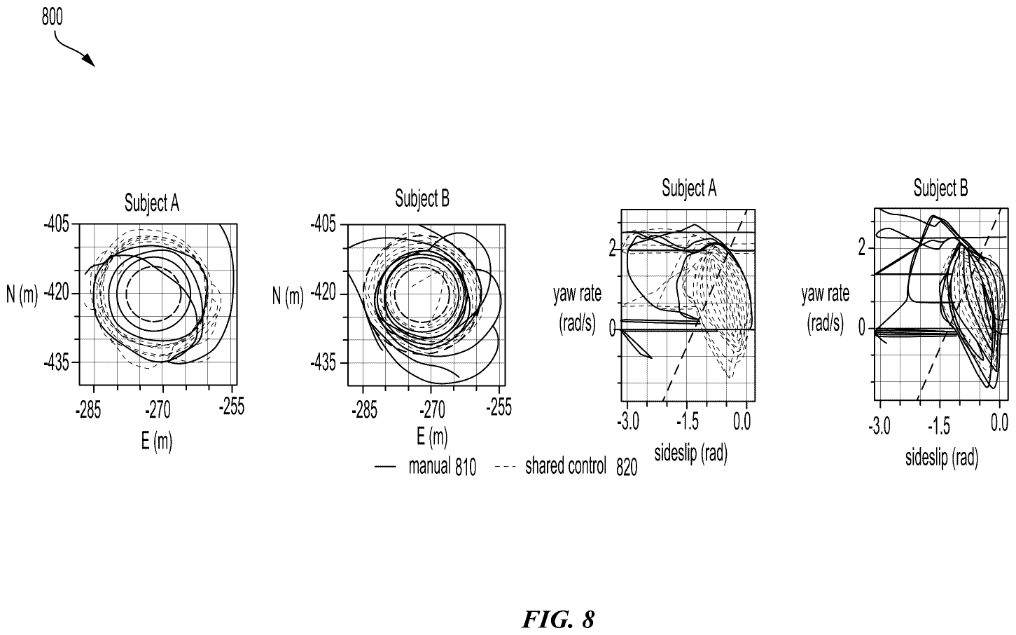

FIG. 8 illustrates trajectory comparison graphs 800 between manual driving 810 and shared control 820, according to various aspects of the present disclosure. As shown in FIG. 8, the dashed lines and the solid line of the left two columns refer to track bounds and reference circle, respectively. The dashed lines of the right column correspond to the linearly approximated maximum phase recovery envelope (MPRE) region 630 of FIG. 6.

In this example, FIG. 8 shows results in terms of course-out and spin-out between manual driving 810 and shared control 820 for the two test participants. The trajectories during manual driving 810 and during the shared control 820 are overlaid for each subject. The left two columns of FIG. 8 depict results related to course-out prevention. The trajectory comparison graphs 800 show the positional trajectories of the vehicles under manual driving 810 and under shared control 820, where the two dashed lines are track bounds and the black solid line is the reference circle. Without shared control 820, both participants tended to go outside the track bounds, since controlling a vehicle for drifting is far different from controlling it in daily driving. Nevertheless, when shared control 820 was activated, both participants could successfully decrease track bound violation in drifting trials. To evaluate the performance to prevent track bound violation, the following metric was defined:

$$Track Violation = {\sum }_{i = 1}^{L} dist ( {e}_{i} ) / L$$

$$dist ( e ) = \{ \begin{matrix}0 & ( {e}_{min} < e < {e}_{max} ) \\ min ( \vert e - {e}_{min} \vert , \vert e - {e}_{max} \vert ) & ( otherwise ) ,\end{matrix}$$

where L is the length of each drift trial and dist(e) function measures the distance between the current position and the closer track bound when the vehicle is outside the track bounds. For example, Table I shows the comparison between the final manual trial and the first shared control trial. This result shows that the track bound violation was decreased by more than 1 meter (m) for both subjects through utilizing shared control.

TABLE I
IMMEDIATE IMPROVEMENTS OF
TRACK AND MPRE VIOLATION

| | Track Violation | | | MPRE Violation | |
|---|---|---|---|---|---|
| | Subject A | Subject B | | Subject A | Subject B |
| Manual | 1.6 (m) | 4.2 | (m) | 0.39 | 0.088 |
| Shared Control | 0.1 (m) | 0.085 | (m) | 0.084 | 0.037 |

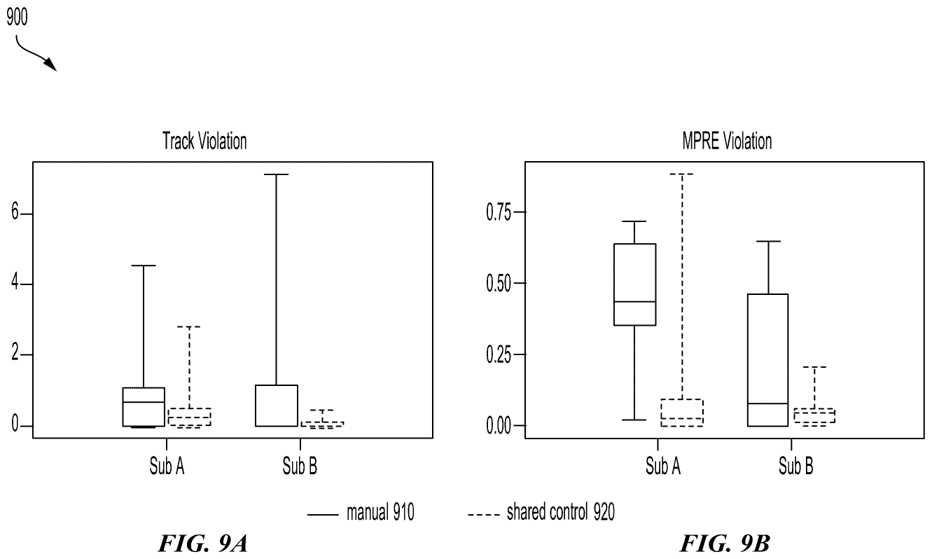

FIGS. 9A and 9B illustrate box plots of violation metrics, in which a line inside the box shows the median value, the box shows the quartile range, and the line outside the box shows the minimum and maximum values, according to various aspects of the present disclosure. In this example, FIG. 9A summarizes an overall performance about track bound violation, and FIG. 9B summarizes an overall performance about MPRE violation between manual operation 910 and shared control 920. Although the difference of median track bound violation was small in subject B, the larger quartile value and interquartile range of track violation were decreased in the shared control tests for both subjects.

Referring again to FIG. 8, the right two columns of FIG. 8 show the comparison of the spin-out prevention between the manual driving 810 and the shared control 820 on a sideslip-yaw rate phase plot. The dashed line represents an approximated MPRE boundary of the MPRE region 620 used for the model predictive control (MPC) cost function. The line beyond β=−π indicates that the vehicle spun-out. In this example, subject A sometimes spun-out in both manual driving and shared control. Additionally, subject B sometimes spun-out in manual driving, but was able to perform drifting without spin-out under shared control. The risk of spin-out metric was evaluated as follows:

$$MPRE Violation = {\sum }_{i = 1}^{L} d i s t ( {β}_{i} , {r}_{i} ) / L$$

$$dist ( β , r ) = \{ \begin{matrix}0 & ( {MPRE}_{p , - q} ( β ) < r < {MPRE}_{p , q} ( β ) ) \\ min ( \vert p β - r \pm q \vert / \sqrt{{p}^{2} + {q}^{2}} ) & ( otherwise ) ,\end{matrix}$$

where MPRE_{p,q}(β) is defined in Eq. (6). The dist(β, r) functions measures the distance between the current state (β, r) and the nearest approximated MPRE boundary line when the current state is outside MPRE. Table I shows the performance comparison between right before and after switching from manual control to shared control. Shared control reduced the risk of spin-out for both subjects. Immediate performance improvement for both track bound violation and MPRE violation suggests that this shared control can increase safety without requiring driver specific training or tuning. The overall performance about MPRE violation is summarized in FIG. 9B. FIG. 9B shows that the median, larger quartile value and interquartile range of the risk of spin-out were decreased with shared control for both subjects.

A test was applied to Track Violation and MPRE Violation results for which normality was established, and A Mann-Whitney U test was applied to the others. Table II shows that when the significance level was set at 5%, significant differences were not found for track violation, but significant differences were found for MPRE violation.

TABLE II
P VALUE OF STATISTICAL TESTS

| | Subject A | Subject B |
|---|---|---|
| Track Violation | 0.4 | 0.05 |
| MPRE Violation | 0.01 | 0.02 |

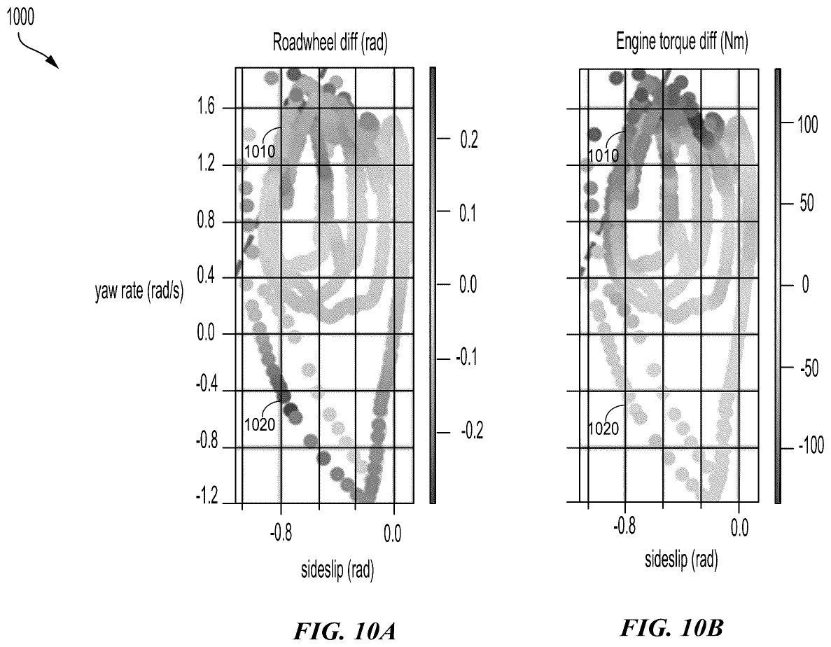

FIGS. 10A and 10B are graphs illustrating an intervention analysis, in which a magnitude of intervention i_{δ} and iᵣ as well as counter steering and engine torque suppression are shown, according to various aspects of the present disclosure. A first pattern 1010 indicates counter-steering and engine torque suppression, and second pattern 1020 indicates the opposite. FIGS. 10A and 10B illustrate an analysis on how shared control intervened a driver command in a trial with participant A. The amount of intervention was calculated as the average difference between a model predictive control (MPC) plan and a driver's requests in the driver respect steps M, such as

$${i}_{δ} = \frac{1}{M} {\sum }_{κ = 1}^{M} {δ}_{κ} - {\hat{δ}}_{drv , κ} and {i}_{τ} = \frac{1}{M} {\sum }_{κ = 1}^{M} {τ}_{κ} - {\hat{τ}}_{drv , κ} .$$

These values are plotted as heat maps in FIGS. 10A and 10B.

As shown in FIGS. 10A and 10B, the first pattern 1010 indicates counter-steering and engine torque suppression, and the second pattern 1020 indicates the opposite. The upper left points of the first pattern 1010 in FIGS. 10A and 10B show that if the vehicle state was predicted to exceed the approximated maximum phase recovery envelope (MPRE) line, the shared controller applied counter-steering and suppressed engine torque to prevent spin-out. The bottom left points of the second pattern 1020 shown in the left column of FIGS. 10A and 10B indicate that the shared controller reversed counter-steering to prevent course-out after an MPRE violation was corrected. Counter-steering is applied to stop spin-out in recovery. Nevertheless, applying counter-steering for too long causes the vehicle to rotate in the opposite direction after rear tires recover their grip, leading to course-out.

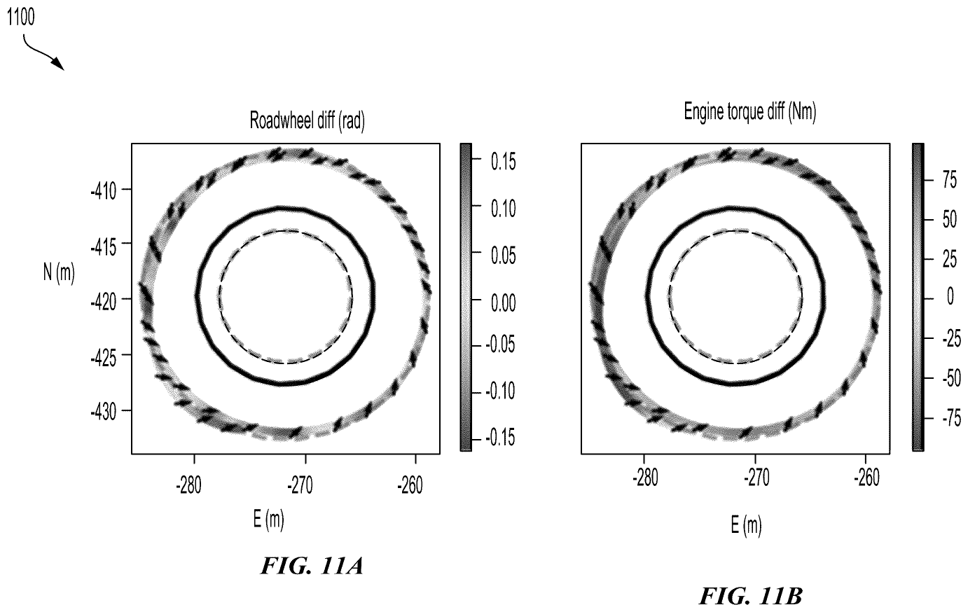

FIGS. 11A and 11B illustrate a novice drifter utilizing the limits of a vehicle stability envelope and environmental constraints, including a roadwheel difference and an engine torque difference, according to various aspects of the present disclosure. As shown in FIGS. 11A and 11B, the arrows represent the direction of the car's heading and the location of the vehicle's center of gravity. The heat map indicates the magnitude of interventions i_{δ} and iᵣ

FIGS. 11A and 11B show an interesting trial of shared control with participant A. The arrows overlaid in certain time intervals represent the direction of the car's heading and the location of the vehicle's center of gravity. Participant A was a novice drifter but was able to continue drifting in a perfect circle on the edge of the track bounds. Shared control helped the driver keep the vehicle in the safe envelope by suppressing engine torque, as shown by the blue points in the right plot. This result is interesting as the novice driver could operate the vehicle safely while utilizing the maximum capability on vehicle stability envelope and environmental constraints.

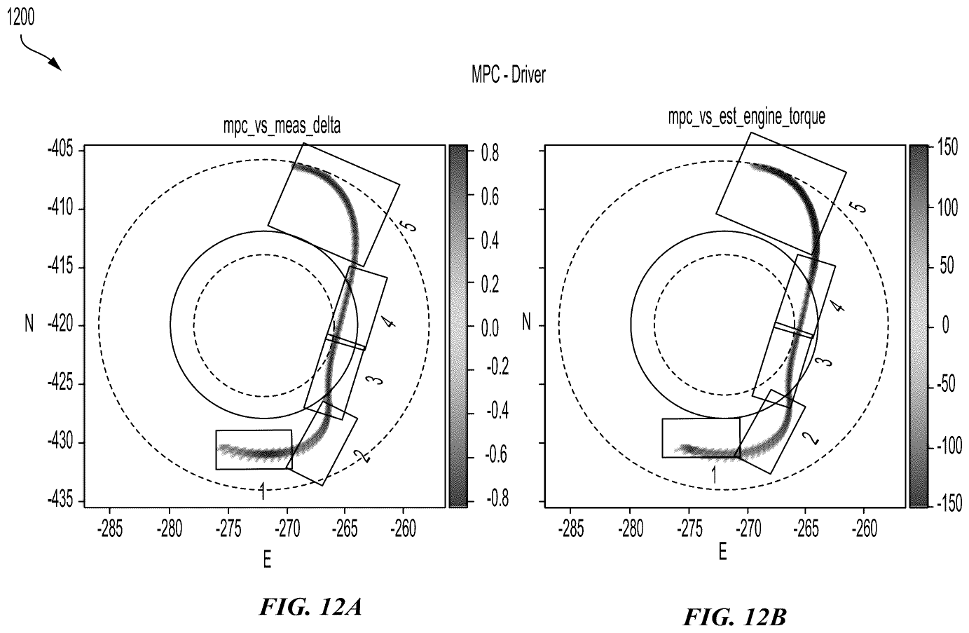

FIGS. 12A and 12B further illustrate a haptic shared control approach that respects safe driver commands, but intervenes when an unsafe driver command is detected, according to various aspects of the present disclosure. As described, a requested driver command is identified as an unsafe driver command if performance of the driver command is predicted to result in a loss of control or a violation of safety constraints, such as track boundaries. Furthermore, the haptic shared control approach successfully intervenes through both grip and drifting, which significantly expands the region of shared control to include even unstable yet controllable states.

In this haptic shared control approach, a model predictive control (MPC) acts to adjust vehicle commands that violate a safety constraint such as a spin-out or violating track bounds. In operation, if a driver's signal is safe, the MPC respects the driver's command; however, if the driver's command is predicted to cause a spin-out, the MPC respects the driver's intent but augments the signal to keep the driver safe by performing an adjusted vehicle command. In various aspects of the present disclosure, the MPC expands haptic shared control approaches to enable operating in extreme and unstable domains, like drifting.

As shown in FIGS. 12A and 12B, the driver commands a constant 0 steering angle and an engine torque of 100 Nm. In this example, an initial state is configured to cause a spin-out if no intervention occurs. FIGS. 12A and 12B depict the vehicle path along with how much intervention the MPC gives for steering (e.g., FIG. 12A) and engine torque (e.g., FIG. 12B). The shades depict the amount of intervention, including a zero intervention, a large negative intervention, and a large positive intervention. Initially, the MPC applies a large intervention depicted by the segment towards the bottom of FIGS. 12A and 12B to prevent the spin-out at the start (segment 1). Then there is little intervention (segment 2) followed by a slight intervention (segment 3) to prevent the driver from violating the inner track bounds (small, dashed circle). After this, there is minimal intervention and the driver's command is respected (segment 4); however, a large intervention occurs again (section 5) to prevent violating the outer track bounds (large, dashed circle).

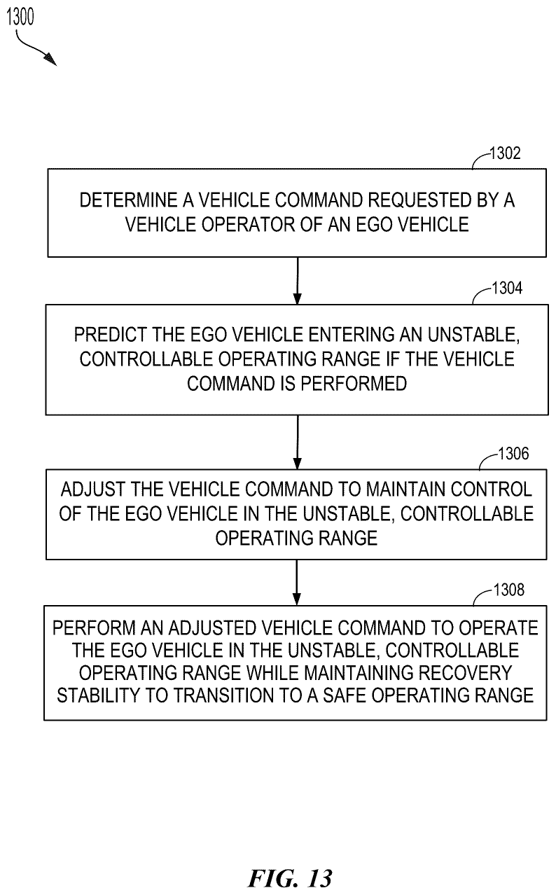

Various aspects of the present disclosure extend the shared control capability from the open-loop stable region to the unstable, controllable region, expanding the vehicle operating range. In various aspects of the present disclosure, an MPC shared controller follows a driver's command unless intervention is specified to prevent dangerous situations. The MPC shared controller seamlessly determines the magnitude of intervention by balancing the cost of following the driver's commands, the cost of preventing a spin-out, and the cost of preventing a course-out. Experimental results showed that the shared control decreased the risk of going out of the track bounds and spin-out compared to the manual driving. Additionally, a novice drifter was able to safely drift along a perfect circle on the edge of virtual track bounds under shared control, while utilizing a maximum capability of the vehicle in terms of the vehicle stability limit and environmental constraints. These aspects of the present disclosure provide a shared control system that allows the ordinary driver to operate maximum capabilities of the vehicle confidently and safely, while preserving options to avoid danger in emergency situations. A method for an attention-based agent interaction system is shown in FIG. 13.

FIG. 13 is a flowchart illustrating a method for a shared control, dynamic driving system, according to aspects of the present disclosure. A method 1300 begins at block 1302, in which a vehicle command requested by a vehicle operator of an ego vehicle is determined. For example, as shown in FIG. 3, the vehicle command module 312 is configured to determine a vehicle command requested by a vehicle operator of an ego vehicle.

At block 1304, the ego vehicle entering an unstable, controllable operating range is predicted if the vehicle command is performed. For example, as shown in FIG. 3, in response to the requested vehicle command, the unsafe command prediction module 314 is configured to predict the ego vehicle entering an unstable, controllable operating range if the requested vehicle command is performed.

At block 1306, the vehicle command is adjusted to maintain control of the ego vehicle in the unstable, controllable operating range. For example, as shown in FIG. 3, in response to detection of an unsafe vehicle command, the adjusted vehicle command module 316 is configured to adjust the vehicle command to prevent the ego vehicle from entering in the unsafe region. In these aspects of the present disclosure, the shared vehicle control, dynamic driving system 300 is configured to extend a vehicle driving envelope of the car 350 to an unstable, controllable envelope MPRE, which is defined by a larger area and sideslip to support higher vehicle agility. For example, the MPRE (maximum phase recovery envelope) may refer to a boundary region in which maximum counter-steering can recover a vehicle state of the car into the SHE region.

At block 1308, an adjusted vehicle command is performed to operate the ego vehicle in the unstable, controllable operating range while maintaining recovery stability to transition to a safe operating range. For example, as shown in FIG. 3, the adjusted command performance module 318 is configured to perform an adjusted vehicle command to operate the ego vehicle in the unstable, controllable operating range while maintaining recovery stability to transition to a safe operating range. As shown in FIG. 6, various aspects of the present disclosure extend the SHE region 610 to an unstable, controllable envelope of the MPRE region 620, which is defined by a larger yaw rate 602 and sideslip 604 to allow higher agility, as shown in an MPRE graph 600. As described, the MPRE region 620 is defined as the boundary region where maximum counter-steering can recover the vehicle state into the SHE region 610.

In some aspects of the present disclosure, the method shown in FIG. 13 may be performed by the SOC 100 (FIG. 1) or the software architecture 200 (FIG. 2) of the vehicle 150. That is, each of the elements or methods may, for example, but without limitation, be performed by the SOC 100, the software architecture 200, the processor (e.g., CPU 102), and/or other components included therein of the vehicle 150, or the shared vehicle control, dynamic driving system 300.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may be implemented using nonlinear model predictive control described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for a shared control, dynamic driving system, the method comprising:
determining a vehicle command requested by a vehicle operator of an ego vehicle;
predicting the ego vehicle entering an unstable, controllable operating range if the vehicle command is performed;
adjusting the vehicle command to maintain control of the ego vehicle in the unstable, controllable operating range; and
performing an adjusted vehicle command to operate the ego vehicle in the unstable, controllable operating range while maintaining recovery stability to transition to a safe operating range.

2. The method of claim 1, in which predicting the ego vehicle entering the unstable, controllable operating range comprises analyzing a cost associated with performing the vehicle command to predict whether the ego vehicle will enter the unstable, controllable operating range.

3. The method of claim 1, in which predicting comprises determining the vehicle command is a violation of a safety constraint.

4. The method of claim 3, in which the safety constraint comprises a spin-out and/or a track bounds violation.

5. The method of claim 1, in which performing comprises operating the ego vehicle in an extreme and/or unstable domain.

6. The method of claim 5, in which the extreme and/or unstable domain comprises performing a drifting maneuver by the ego vehicle.

7. The method of claim 1, in which performing comprises providing haptic feedback to a driver of the ego vehicle during the performing of the adjusted vehicle command.

8. The method of claim 1, in which the adjusted vehicle command comprises an adjusted steering and/or engine torque of the ego vehicle.

9. A non-transitory computer-readable medium having program code recorded thereon for a shared control, dynamic driving system, the program code being executed by a processor and comprising:
program code to determine a vehicle command requested by a vehicle operator of an ego vehicle;
program code to predict the ego vehicle entering an unstable, controllable operating range if the vehicle command is performed;
program code to adjust the vehicle command to maintain control of the ego vehicle in the unstable, controllable operating range; and
program code to perform an adjusted vehicle command to operate the ego vehicle in the unstable, controllable operating range while maintaining recovery stability to transition to a safe operating range.

10. The non-transitory computer-readable medium of claim 9, in which the program code to predict the ego vehicle entering the unstable, controllable operating range comprises program code to analyze a cost associated with performing the vehicle command to predict whether the ego vehicle will enter the unstable, controllable operating range.

11. The non-transitory computer-readable medium of claim 9, in which the program code to predict comprises program code to determine the vehicle command is a violation of a safety constraint.

12. The non-transitory computer-readable medium of claim 11, in which the safety constraint comprises a spin-out and/or a track bounds violation.

13. The non-transitory computer-readable medium of claim 9, in which the program code to perform comprises program code to operate the ego vehicle in an extreme and/or unstable domain.

14. The non-transitory computer-readable medium of claim 13, in which the program code to operate the ego vehicle in the extreme and/or unstable domain comprises program code to perform a drifting maneuver by the ego vehicle.

15. The non-transitory computer-readable medium of claim 9, in which the program code to perform comprises program code to provide haptic feedback to a driver of the ego vehicle during the performing of the adjusted vehicle command.

16. The non-transitory computer-readable medium of claim 9, in which the adjusted vehicle command comprises an adjusted steering and/or engine torque of the ego vehicle.

17. A system for a shared control, dynamic driving system, the system comprising:
a vehicle command module to determine a vehicle command requested by a vehicle operator of an ego vehicle;
an unsafe command prediction module to predict the ego vehicle entering an unstable, controllable operating range if the vehicle command is performed;
an adjusted vehicle command module to adjust the vehicle command to maintain control of the ego vehicle in the unstable, controllable operating range; and
an adjusted command performance module to perform an adjusted vehicle command to operate the ego vehicle in the unstable, controllable operating range while maintaining recovery stability to transition to a safe operating range.

18. The system of claim 17, in which the unsafe command prediction module is further to analyze a cost associated with performing the vehicle command to predict whether the ego vehicle will enter the unstable, controllable operating range.

19. The system of claim 17, in which the adjusted command performance module is further to operate the ego vehicle in performing a drifting maneuver.

20. The system of claim 17, in which the adjusted command performance module is further to provide haptic feedback to a driver of the ego vehicle during the performing of the adjusted vehicle command.
